(19) United States
(12) Patent Application Publication
(10) Pub. No.: US 2004/0121816 A1
(43) Pub. Date: Jun. 24, 2004

(54) Cellular phone with directional navigational keys used to replace buttons and method for using these keys

(76) Inventor: Brian Yang, Hsinchu (TW)

Correspondence Address: Elliott N. Kramsky, Esq., Suite 400, 5850 Canoga Avenue, Woodland Hills, CA, 91367, US

(21) Appl. No.: 10/452,599

(22) Filed: Jun. 2, 2003

(30) Foreign Application Priority Data
Dec. 18, 2002 (TW) 091136585

(51) Int. Cl. H04M 1/00; H04B 1/38

(52) U.S. Cl. 455/565; 455/550.1

(57) ABSTRACT

A cellular phone with directional navigational keys used to replace conventional buttons comprises several directional navigational keys that totalize all traditional button functions in them. The directional navigational key can be 9-directional navigational key, and the 9 directions are upper, lower, left, right, upper right, upper left, lower right, lower left and perpendicular directions. Simply pressing the directional navigational key toward a particular direction among 9 directions to input a number or symbol. Thereby, a convenient operation and small size can be obtained for a cellular phone.

### BACKGROUND OF THE INVENTION

1. Field of the Invention

The present invention relates to a cellular phone with directional navigational keys used to replace buttons and a method for using these keys, and more particularly to a cellular phone with navigational keys used to input numbers and symbols and a method for inputting numbers and symbols through a directional navigational key.

2. Description of Related Art

The buttons of the keypad of a conventional cellular phone at least comprises number buttons 0 to 9, symbol buttons * and # and four function buttons and are always over 16 buttons. The buttons occupy a lot of space on the keypad. It is without doubt that the buttons will become an obstacle for the minimization of the body of a cellular phone and the enlargement of the screen of a cellular phone. And, not only the space cannot be saved a lot but also operation becomes inconvenient even if the buttons are made smaller in size, especially for a person with big hands. Therefore, the input manner must be improved if the space is needed to save and the operation convenience is required.

### SUMMARY OF THE INVENTION

In order to reduce the numbers of buttons on the keypad of a cellular phone, the present invention proposes a directional navigational key (a general directional navigational key is only used to choose the direction of a cursor) similar to a joystick to replace the conventional buttons. It corresponds the buttons, which comprises 9 number buttons, “*” and “#” symbol buttons and a several function buttons, on a conventional cellular phone to the directions on directional navigational keys so as to save the space occupied by the buttons. Therefore, only two directional navigational keys are needed to cover the functions of all buttons.

The main object of the present invention is to provide a cellular phone with directional navigational keys used to replace buttons and a method for using these keys, the directional pressing of a directional navigational key is used to input numbers or symbols so as to allow an input operation to be convenient and fast.

Another object of the present invention is to provide a cellular phone with directional navigational keys used to replace buttons and a method for using these keys; a small number of navigational keys are used to replace a large number of buttons so that a large space in a cellular phone is saved.

### BRIEF DESCRIPTION OF THE DRAWINGS

The present invention can be more fully understood by reference to the following description and accompanying drawings, in which:

FIG. 1 is a schematic view of a preferred embodiment according to the present invention, showing how buttons on a conventional cellular phone is corresponded to the directions of a 9-directional navigational key;

FIG. 2 is a flow chart, showing procedures for processing a dialing on a cellular phone with two 9-directional navigational keys.

### DETAILED DESCRIPTION OF THE PREFERRED EMBODIMENTS

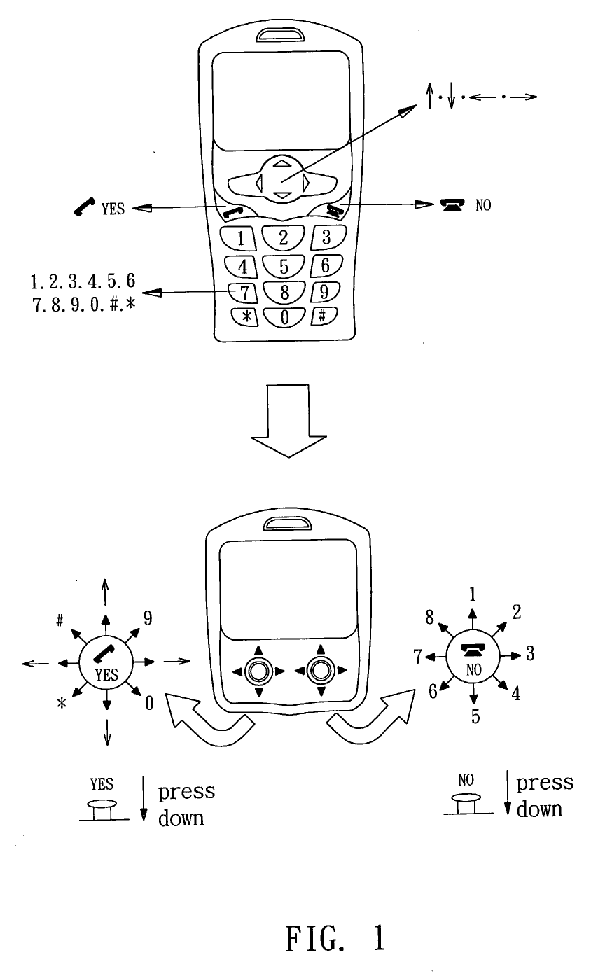

Please refer to FIG. 1. FIG.1 is a schematic view of a preferred embodiment according to the present invention, showing how buttons on a conventional cellular phone is corresponded to the directions of a 9-directional navigational key. Each stick type 9-directional navigational key comprises 9 pressing directions, i.e. upward, downward, leftward, rightward, up rightward, down rightward, up leftward, down leftward and perpendicular directions. Here, the pressings of a directional navigational key at the right side stand for number “1”, “2”, “3”, “4”, “5”, “6”, “7” and “8” clockwise from the upward direction, and the perpendicular pressing of the 9-directional navigational key at the right side represents the “Cancel” or “End Call”. The pressings of a directional navigational key at the left side stand for “Upward”, “9”, “Rightward”, “0”, “Downward”, “*”, “Leftward” and “#” number or symbol clockwise from the upward direction, and the perpendicular pressing of the 9-directional navigational key at the left side represents the “Pick” or “Dial out” button. The navigational key is pressed toward a particular direction or pressed down when a particular number or symbol is input, and then is released to spring back to its original center place or its original height. Thereafter, the directional navigational key is pressed toward another particular direction or pressed down when another particular number or symbol is input, and then is released to spring back to its original center place or original height; these steps are repeated and repeated again in order to input a data or command. For example, if we want to input number “1”, use a thumb to press the directional navigational key at the right upward and then lift the thumb to release the direction navigational key to spring back to its original center place, number “1” is input as a result. If we want to input a “Upward” command, use only the thumb to press the directional navigational key at the left side upward and then lift the thumb to release the directional navigational key to spring back to its original center place, a cursor on the screen of a cellular phone is moved upward at this moment. According to the conventional keypad, “2” number button has alphabets “abc” thereon, “3” number button has “def” thereon, and so on. A similar arrangement is adopted in the present invention. For example, if we want to input the alphabet “f”, press the directional navigational key at the right side rightward (i.e., the direction for input number “3”) three times continuously until alphabet “f” is appeared on the screen. Other alphabets are input in the same way.

The directional navigational key according to the present invention is not limited to the one with nine directions; it can be the one with 4, 5, 8 or a number even higher than 9 directions. The number of the directional navigational keys is also not limited to 2. Depending on requirement of use, a several pressing-down type buttons can be installed on the keypad of a cellular phone together with the directional navigational keys according to the present invention. (not shown in the figures)

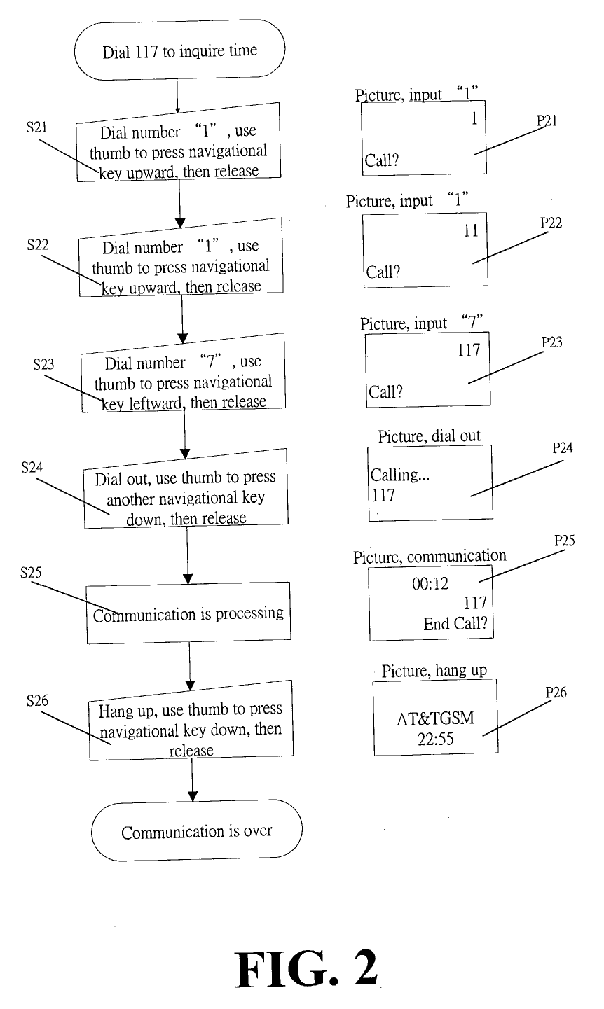

Please refer to FIG. 2. FIG. 2 is a flow chart, showing procedures for processing a dialing on a cellular phone with two 9-directional navigational keys. Here, telephone number 117 (a telephone number in Taiwan for inquiring time) is taken as an example to illustrate dialing procedures according to the present invention and corresponding pictures shown on the screen of a cellular phone. First of all, dial number “1” by using a thumb to press the directional navigational key at the right side upward, and then releasing the thumb to allow the navigational key to spring back to the original center place (Step 21, Picture 21). Then, dial next number “1” by using a thumb again to press the directional navigational key at the right side upward, and then releasing the thumb to allow the navigational key to spring back to the original center place (Step 22, Picture 22). Next, dial number “7” by using a thumb to press the directional navigational key at the right side leftward, and then releasing the thumb to allow the navigational key to spring back to the original center place (Step 23, Picture 23). Finally, dial out the number by using a thumb to press down the directional navigational key at left side directly, and then releasing the thumb to allow the navigational key to spring up to the original height (Step 24, Picture 24). After the phone call is made, the telephone line is busy (Step 25, Picture 25), communication time will be shown on the screen at the same time (e.g., 00:12 shown in the picture P25). After hearing the time, hang up the telephone by using a thumb to press down the 9-directional navigational key at the right side, and then releasing the thumb to allow the navigational key to spring to the original height (Step S26, Picture P26). Thereafter, the communication is over.

It is noted that the cellular phone with directional navigational keys used to replace buttons and a method for using these keys described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A cellular phone with directional navigational keys used to replace buttons, having a directional navigational key or a plurality of directional navigational keys installed thereon, wherein said directional navigational key can be pressed toward a several directions to input alphabets or numbers.

2. The cellular phone according to claim 1, wherein said directional navigational key is a 9-directional navigational key; said 9 directions are upward, downward, leftward, rightward, upper rightward, upper leftward, down rightward, down leftward and perpendicular.

3. The cellular phone according to claim 2, wherein the number of said directional navigational keys is two.

4. The cellular phone according to claim 3 wherein the pressing of one of said directional navigational keys started from said upward direction and proceeded clockwise in sequence represents the input of numbers “1”, “2”, “3”, “4”, “5”, “6”, “7” and “8”, and said perpendicular pressing of said directional navigational key represents the input of “Cancel” or “End Call”; another one of said directional navigational keys started from said upward direction and proceeded clockwise in sequence represents the input of numbers and symbols “Upward”, “9”, “Rightward”, “0”, “Downward”, “*”, “Leftward” and “#”, and said perpendicular pressing of said another directional navigational key represents the input of “Pick” or “Dial out”.

5. The cellular phone according to claim 1 wherein a function symbol represented by each said direction is marked around said directional navigational key.

6. The cellular phone according to claim 1 wherein a function symbol of said perpendicular pressing is marked at the top end of said directional navigational key.

7. The cellular phone according to claim 1, wherein several buttons are disposed on a keypad of said cellular phone used in coordination with said directional navigational key.

8. A method for using a directional key on a cellular phone, mainly using a finger to press a directional navigational key toward a certain direction or to press said directional navigational key to input a number or symbol to said cellular phone, and then, releasing said finger to allow said directional navigational key to spring back to an original center place or original height thereof; thereafter, using said finger again to press said directional navigational key toward a same or different direction to input a same or different number or symbol, releasing said finger again to allow said directional navigational-key to spring back to spring back to an original center place or original height thereof; repeating said pressing action to input a data or command.

9. A method for inputting an alphabet by using a directional navigational key on a cellular phone, mainly using finger to press a directional navigational key toward a certain direction once or several times until an expected alphabet appears on a screen of said cellular phone.
